(19) United States
(12) Patent Application Publication
(10) Pub. No.: US 2022/0398245 A1
(43) Pub. Date: Dec. 15, 2022

(54) TIME AWARE CACHING

(71) Applicant: VMware, Inc., Palo Alto, CA (US)

(72) Inventors: Charlie Liu, Palo Alto, CA (US); Chris Dent, Cornwall (GB); Akash Gangil, Palo Alto, CA (US)

(73) Assignee: VMware, Inc., Palo Alto, CA (US)

(21) Appl. No.: 17/345,533

(22) Filed: Jun. 11, 2021

(51) Int. Cl. G06F 16/2453; G06F 9/54

(52) U.S. Cl. CPC G06F 16/2453; G06F 9/544

(57) ABSTRACT

The present disclosure relates to time aware caching. One method includes receiving an API request for data from a database, wherein the request defines a time window associated with the data, creating a first and second query based on the request, wherein the first query corresponds to a first chunk of the time window, and wherein the second query corresponds to a second chunk of the time window, hashing a first statement associated with the first query to produce a first key and hashing a second statement associated with the second query to produce a second key, retrieving a first portion of the data corresponding to the first chunk of the time window from cache responsive to a determination that the first key is in the cache, and retrieving a second portion of the data corresponding to the second chunk of the time window from the database responsive to a determination that the second key is not in the cache.

### BACKGROUND

Application Programming Interfaces (APIs) for time series and other time-based systems may have time constructs in their specification that determine the bounding time window of data to be queried. Retrieving data, especially large amounts of data, covering the full extent of a time window can cause high latency and/or low stability on either or both an API server and its persistence layer.

To address this, some previous approaches attempt to cache entire result sets. With large amounts of data, significant resources may be utilized to achieve a desirable cache hit ratio. Other approaches may attempt to pre-fetch data into a cache based on previously seen queries. Such an approach may rely on a level of request predictability not present in some environments.

### BRIEF DESCRIPTION OF THE DRAWINGS

FIG. 1 is a diagram illustrating a request for data and queries created based on the request according to one or more embodiments of the present disclosure.

FIG. 2 is a flow chart associated with time aware caching according to one or more embodiments of the present disclosure.

FIG. 3 is a diagram of a system for time aware caching according to one or more embodiments of the present disclosure.

FIG. 4 is a diagram of a machine for time aware caching according to one or more embodiments of the present disclosure.

FIG. 5 illustrates a method of time aware caching according to one or more embodiments of the present disclosure.

FIG. 6 is a diagram of a host and a system for time aware caching according to one or more embodiments of the present disclosure.

### DETAILED DESCRIPTION

Application Programming Interfaces (APIs) for time series data and other time-based systems may have time constructs in their specification that determine the bounding time window of data to be queried. Retrieving data, especially large amounts of data, covering the full extent of a time window can cause high latency and/or low stability on either or both an API server and its persistence layer.

For purposes of illustration, the present disclosure discusses time series data using an example of performance indicators for cellular towers. For example, time series data can include average throughput over an uplink. It is noted, however, that embodiments of the present disclosure are not so limited and other time series data can be used. For example, as known to those of skill in the art, time series data includes sensor data, weather data, economic data, application performance monitoring data, network data, events, etc. Where the term “data” is used herein, such reference may refer to time-series data.

In some instances, such data is stable after an initial period of instability. Once stable, this data is a good candidate for caching. Latency and/or stability issues can be mitigated by integrating a cache system to offload traffic towards the database and reduce latency for retrievals. This may be difficult to achieve for request-based caches as they cover a specific time window that may vary from request to request, which may create frequent cache misses. The increase in cache misses results in higher database load, increased HTTP request and storage query latency, and/or increased resource usage. Also resulting from cache misses on request-based caches is cached data that consumes resources but is not retrieved because its key is too specific.

Embodiments of the present disclosure reduce perceived request latency in high traffic environments by implementing “time aware caching” using a key-value cache (e.g., in an API server). API requests for data during a time window can be broken down into queries that correspond to portions of the window (referred to herein as “chunks”) and sent to the persistence layer to reduce the impact of network latency when retrieving data. In some embodiments, a relatively small quantity of queries can be created (e.g., 10); in some embodiments, a relatively large quantity of queries can be created (e.g., 100,000). While the persistence layer can handle a high query load, increased parallelism can increase individual query latency.

Embodiments herein alleviate some of this latency by utilizing consistent time chunks for queries (e.g., every ten minutes, every hour, etc.) and using a hash (e.g., SHA1) of each query statement as the cache key. This generated hash is unique but also reproducible for subsequent requests as the chunk of time for each query combined can be combined with the query statement and hashed.

In accordance with the present disclosure, subsequent API requests have a greater chance of a cache hit because while there may not be exact overlap in time windows for similar requests, one or more of the queries that combine to form a full result set may overlap. Embodiments herein take advantage of fast key-value lookups provided by key-value caches and can maintain a consistent cache hit ratio. Additionally, API requests which may not be similar will sometimes use the same set of base data queries, availing themselves of the cache, but then perform different in-server aggregation and/or other calculations to create a result set. Accordingly, embodiments herein can operate with different granularities of aggregation.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

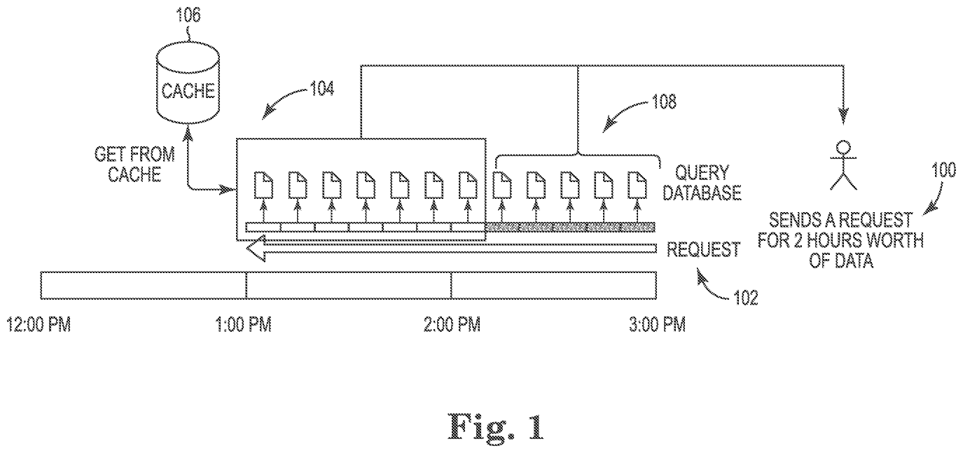

The figures herein follow a numbering convention in which the first digit or digits correspond to the drawing figure number and the remaining digits identify an element or component in the drawing. Analogous elements within a Figure may be referenced with a hyphen and extra numeral or letter. Such analogous elements may be generally referenced without the hyphen and extra numeral or letter. For example, elements 108-1, 108-2, and 108-N in FIG. 1 may be collectively referenced as 108. As used herein, the designator “N”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a diagram illustrating a request for data and queries created based on the request according to one or more embodiments of the present disclosure. Generally, an API request for data over a specified time window is received by an API server. The API server can break down the request and create a plurality of database queries with smaller time chunks within the initial requested time window. The generated query statements can be hashed and the cache can be checked for their presence. For each query, if the key is present in the cache, then the corresponding data is retrieved from the cache. If the key is not present, then the data is retrieved from the database. The data retrieved from the database can be mapped to the hash and cached for subsequent queries. This process can be repeated for each created query. The cached data is subsequently retrieved if it falls within the time window of a subsequent request.

At 100, an API request is made for data over a specified time window. As shown in the example illustrated in FIG. 1, the request 102 is for data over a two-hour window from 1:00 pm to 3:00 pm. The API server can break down the request 102 and create a plurality of database queries with smaller time chunks within the initial requested time window. As shown in the example illustrated in FIG. 1, based on the request 102, twelve queries for 12 chunks are created. The duration and/or size of the chunks can be determined based on the size of the window. For instance, a window exceeding a window size threshold may cause the determination of chunks that exceed a chunk duration threshold and vice versa. A 5 hour window may yield one-hour chunks, while a 40 minute window may yield ten-minute chunks.

The generated query statements can be hashed and a cache 106 can be checked for their presence. For each query, if the key is present in the cache 106, then the corresponding data is retrieved from the cache 106. If the key is not present, then the data is retrieved from the database. As shown in the example illustrated in FIG. 1, for each of a first group of chunks 104, the key is present in the cache 106 and the corresponding data for those seven chunks is retrieved from the cache 106. For each of a second group of chunks 108, the key is not present in the cache 106, and the corresponding data for those five chunks is retrieved from the database. As previously discussed, the data retrieved from the database can be mapped to the hash and cached for subsequent queries. This process can be repeated for each created query. The cached data is subsequently retrieved if it falls within the time window of a subsequent request. Stated differently, the data retrieved from the database corresponding to the group of chunks 108 can be mapped to the hash and cached. Then, if a later request overlaps with a period of time between approximately 2:10 pm and 3:00 pm, the data corresponding to that period has already been cached and can be retried from the cache 106.

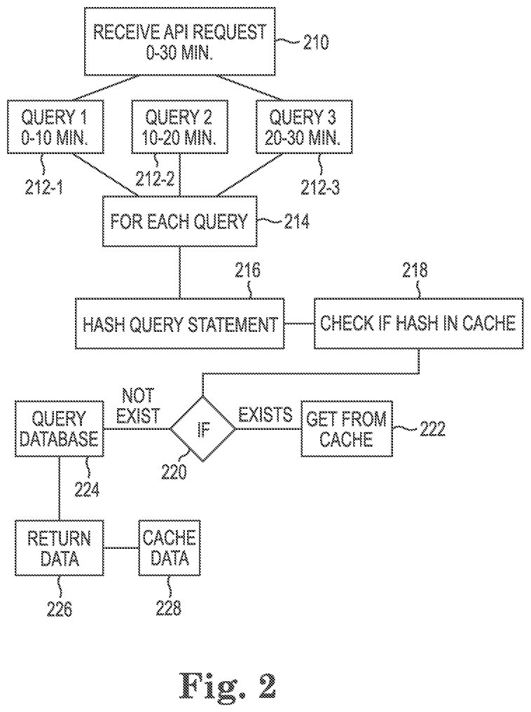

FIG. 2 is a flow chart associated with time aware caching according to one or more embodiments of the present disclosure. At 210, an API request is received. In the example illustrated in FIG. 2, the request defines a 30 minute window for the data. Based on the request, a first query 212-1, a second query 212-2, and a third query 212-3 are created. The first query 212-1 corresponds to a first chunk of the window (e.g., 0-10 minutes), the second query 212-2 corresponds to a second chunk of the window (e.g., 10-20 minutes), and the third query 212-3 corresponds to a third chunk of the window (e.g., 20-30 minutes). In some embodiments, the chunks are a same duration. In some embodiments, one or more of the chunks is a different duration. In some embodiments, a first chunk of a window (e.g., a chunk at the beginning of the window) may be shorter in duration.

Beginning at 214, each query can be processed independently. For example, at 216, a statement of the query can be hashed to produce a key. The cache can be checked at 218. A determination regarding whether the key exists in the cache can be made at 220. If the key exists in the cache, a portion of the data corresponding to the chunk can be retrieved from the cache at 222. If the key does not exist in the cache, the database (e.g., Cassandra) can be queried for the data at 224 and the data can be returned at 226. As previously discussed, embodiments herein can cache retrieved data for later use. At 228, the data retrieved from the database can be cached. Any subsequent request for a time window that includes that chunk can yield a cache hit for the chunk.

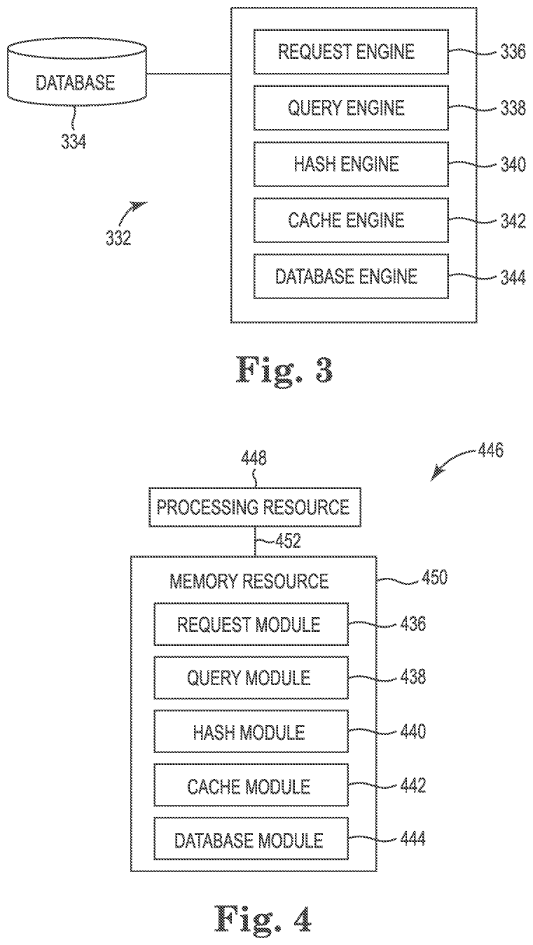

FIG. 3 is a diagram of a system 332 for time aware caching according to one or more embodiments of the present disclosure. The system 332 can include a database 334 and/or a number of engines, for example request engine 336, query engine 338, hash engine 340, cache engine 342, and/or database engine 344, and can be in communication with the database 334 via a communication link. The system 332 can include additional or fewer engines than illustrated to perform the various functions described herein. The system can represent program instructions and/or hardware of a machine (e.g., machine 446 as referenced in FIG. 4, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware. In some embodiments, the request engine 336 can include a combination of hardware and program instructions that is configured to receive an API request for data from a database, wherein the request defines a time window of the data.

In some embodiments, the query engine 338 can include a combination of hardware and program instructions that is configured to create a first query and a second query based on the request, wherein the first query corresponds to a first chunk of the time window, and wherein the second query corresponds to a second chunk of the time window. In some embodiments, the hash engine 340 can include a combination of hardware and program instructions that is configured to hash a first statement associated with the first query and a second statement associated with the second query. In some embodiments, the cache engine 342 can include a combination of hardware and program instructions that is configured to retrieve a first portion of the data corresponding to the first chunk of the time window from cache responsive to a determination that a key corresponding to the hash of the first statement is in the cache. In some embodiments, the database engine 344 can include a combination of hardware and program instructions that is configured to retrieve the first portion of the data corresponding to the first chunk of the time window from the database responsive to a determination that the key corresponding to the hash of the first statement is not in the cache.

FIG. 4 is a diagram of a machine for time aware caching according to one or more embodiments of the present disclosure. The machine 446 can utilize software, hardware, firmware, and/or logic to perform a number of functions. The machine 446 can be a combination of hardware and program instructions configured to perform a number of functions (e.g., actions). The hardware, for example, can include a number of processing resources 448 and a number of memory resources 450, such as a machine-readable medium (MRM) or other memory resources 450. The memory resources 450 can be internal and/or external to the machine 446 (e.g., the machine 446 can include internal memory resources and have access to external memory resources). In some embodiments, the machine 446 can be a virtual computing instance (VCI). The program instructions (e.g., machine-readable instructions (MM)) can include instructions stored on the MRM to implement a particular function (e.g., an action such as receiving a plurality of metrics, as described herein). The set of MRI can be executable by one or more of the processing resources 448. The memory resources 450 can be coupled to the machine 446 in a wired and/or wireless manner. For example, the memory resources 450 can be an internal memory, a portable memory, a portable disk, and/or a memory associated with another resource, e.g., enabling MM to be transferred and/or executed across a network such as the Internet. As used herein, a “module” can include program instructions and/or hardware, but at least includes program instructions.

Memory resources 450 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 448 can be coupled to the memory resources 450 via a communication path 452. The communication path 452 can be local or remote to the machine 446. Examples of a local communication path 452 can include an electronic bus internal to a machine, where the memory resources 450 are in communication with the processing resources 408 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 452 can be such that the memory resources 450 are remote from the processing resources 448, such as in a network connection between the memory resources 450 and the processing resources 448. That is, the communication path 452 can be a network connection. Examples of such a network connection can include a local area network (LAN), wide area network (WAN), personal area network (PAN), and the Internet, among others.

As shown in FIG. 4, the MRI stored in the memory resources 450 can be segmented into a number of modules 436, 438, 440, 442, 444 that when executed by the processing resources 448 can perform a number of functions. As used herein a module includes a set of instructions included to perform a particular task or action. The number of modules 436, 438, 440, 442, 444 can be sub-modules of other modules. For example, the hash module 440 can be a sub-module of the cache module 442 and/or can be contained within a single module. Furthermore, the number of modules 436, 438, 440, 442, 444 can comprise individual modules separate and distinct from one another. Examples are not limited to the specific modules 436, 438, 440, 442, 444 illustrated in FIG. 4.

Each of the number of modules 436, 438, 440, 442, 444 can include program instructions and/or a combination of hardware and program instructions that, when executed by a processing resource 448, can function as a corresponding engine as described with respect to FIG. 3. For example, the request module 436 can include program instructions and/or a combination of hardware and program instructions that, when executed by a processing resource 448, can function as the request engine 336, though embodiments of the present disclosure are not so limited. The machine 446 can include a request module 436, which can include instructions to receive an API request for data from a database, wherein the request defines a time window of the data. The machine 446 can include a query module 438, which can include instructions to create a first query and a second query based on the request, wherein the first query corresponds to a first chunk of the time window, and wherein the second query corresponds to a second chunk of the time window. The machine 446 can include a hash module 440, which can include instructions to hash a first statement associated with the first query and a second statement associated with the second query. The machine 446 can include a cache module 442, which can include instructions to retrieve a first portion of the data corresponding to the first chunk of the time window from cache responsive to a determination that a key corresponding to the hash of the first statement is in the cache. The machine 446 can include a database module 444, which can include instructions to retrieve the first portion of the data corresponding to the first chunk of the time window from the database responsive to a determination that the key corresponding to the hash of the first statement is not in the cache.

In some embodiments, the machine 446 includes instructions to retrieve a second portion of the data corresponding to the second chunk of the time window from cache responsive to a determination that a key corresponding to the hash of the second statement is in the cache and retrieve the second portion of the data corresponding to the second chunk of the time window from the database responsive to a determination that the second key is not in the cache.

In some embodiments, the machine 446 includes instructions to retrieve the first portion of the data corresponding to the first chunk of the time window from the database regardless of whether (or even if) the key corresponding to the first statement is in the cache. For instance, the first portion of the data can be retrieved from the database responsive to an indication made by a user not to retrieve the first portion of the data from cache. In some embodiments, the first portion of the data can be retrieved from the database even if the key corresponding to the first statement is in the cache responsive to a determination that the first portion of the data does not exceed an age threshold. In time series data, for instance, some amount of time may pass before data becomes truly static. In one example, embodiments of the present disclosure can retrieve data from the database, instead of the cache, if the data does not exceed an age threshold (e.g., is less than 20 minutes old).

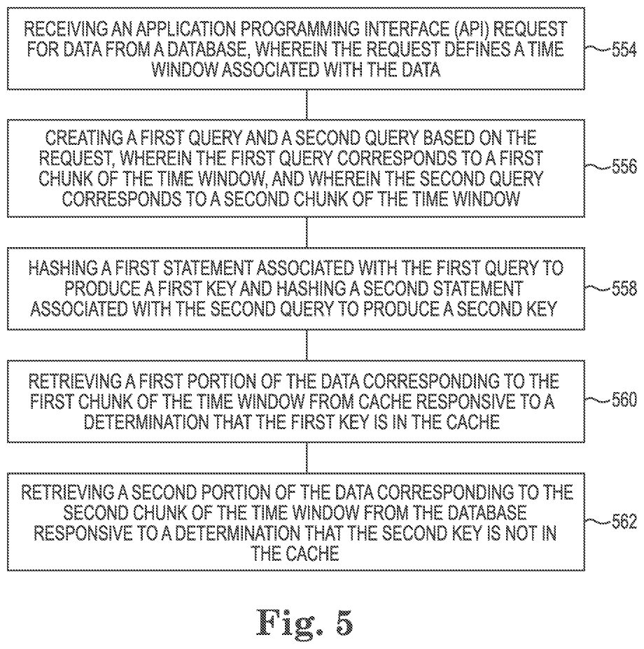

FIG. 5 illustrates a method of time aware caching according to one or more embodiments of the present disclosure. At 554, the method includes receiving an application programming interface (API) request for data from a database, wherein the request defines a time window associated with the data. At 556, the method includes creating a first query and a second query based on the request, wherein the first query corresponds to a first chunk of the time window, and wherein the second query corresponds to a second chunk of the time window. At 558, the method includes hashing a first statement associated with the first query to produce a first key and hashing a second statement associated with the second query to produce a second key. At 560, the method includes retrieving a first portion of the data corresponding to the first chunk of the time window from cache responsive to a determination that the first key is in the cache. At 562, the method includes retrieving a second portion of the data corresponding to the second chunk of the time window from the database responsive to a determination that the second key is not in the cache.

In some embodiments, the method includes caching the second portion of the data subsequent to retrieving the second portion of the data from the database. As previously discussed, the cached second portion can be later retrieved. Some embodiments, for instance, include receiving a subsequent API request for data from the database, wherein the subsequent request defines the time window associated with the data, creating the first query and the second query based on the subsequent request, wherein the first query corresponds to the first chunk of the time window, and wherein the second query corresponds to the second chunk of the time window, hashing the first statement associated with the first query to produce the first key and hashing the second statement associated with the second query to produce the second key, retrieving the first portion of the data corresponding to the first chunk of the time window from cache responsive to a determination that the first key is in the cache, and retrieving the second portion of the data corresponding to the second chunk of the time window from the cache responsive to a determination that the second key is in the cache.

Some embodiments include receiving a further API request for data from the database, wherein the further request defines a different time window associated with the data, and wherein the different time window includes the second chunk, creating the second query and a third query based on the further request, wherein the third query corresponds to a third chunk of the different time window, hashing the second statement associated with the second query to produce the second key and hashing a third statement associated with the third query to produce a third key, retrieving the second portion of the data corresponding to the second chunk from cache responsive to a determination that the second key is in the cache, and retrieving a third portion of the data corresponding to the third chunk of the different time window from the database responsive to a determination that the third key is not in the cache.

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may utilize data storage and/or data processing services from the provider in order to run applications that handle the enterprises' core business and operational data. The applications may be proprietary and used exclusively by the enterprise or made available through a network for anyone to access and use.

VCIs, such as virtual machines and containers, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software-defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others

The term VCI refers generally to an isolated user space instance, which can be executed within a virtualized environment. Other technologies aside from hardware virtualization can provide isolated user space instances, also referred to as data compute nodes. Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

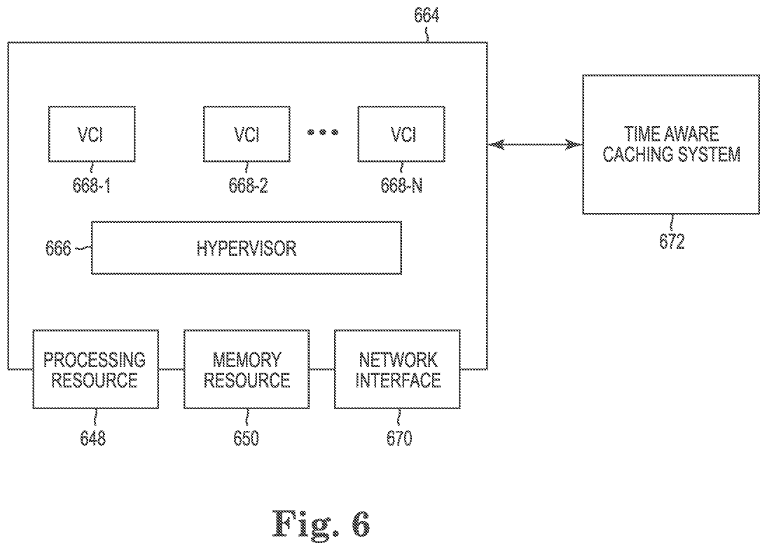

FIG. 6 is a diagram of a host and a system for time aware caching according to one or more embodiments of the present disclosure. The system can include a host 664 with processing resources 648 (e.g., a number of processors), memory resources 650, and/or a network interface 670. The host 664 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 664 can incorporate a hypervisor 666 that can execute a number of virtual computing instances 668-1, 668-2, . . . , 668-N (referred to generally herein as “VCIs 668”). The VCIs 668 can be provisioned with processing resources 648 and/or memory resources 650 and can communicate via the network interface 670. The processing resources 648 and the memory resources 650 provisioned to the VCIs can be local and/or remote to the host 664. For example, in a software defined data center, the VCIs 668 can be provisioned with resources that are generally available to the software defined data center and not tied to any particular hardware device. By way of example, the memory resources 650 can include volatile and/or non-volatile memory available to the VCIs 668. The VCIs 668 can be moved to different hosts (not specifically illustrated), such that a different hypervisor manages the VCIs 668. The host 664 can be in communication with a time aware caching system 672. An example of the time aware caching system is illustrated and described in more detail above. In some embodiments, the time aware caching system 672 can be a server, such as a web server and/or API server.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving an application programming interface (API) request for data from a database, wherein the request defines a time window associated with the data;
creating a first query and a second query based on the request, wherein the first query corresponds to a first chunk of the time window, and wherein the second query corresponds to a second chunk of the time window;
hashing a first statement associated with the first query to produce a first key and hashing a second statement associated with the second query to produce a second key;
retrieving a first portion of the data corresponding to the first chunk of the time window from cache responsive to a determination that the first key is in the cache; and
retrieving a second portion of the data corresponding to the second chunk of the time window from the database responsive to a determination that the second key is not in the cache.

2. The method of claim 1, wherein the method includes caching the second portion of the data subsequent to retrieving the second portion of the data from the database.

3. The method of claim 2, wherein the method includes:
receiving a subsequent API request for data from the database, wherein the subsequent request defines the time window associated with the data;
creating the first query and the second query based on the subsequent request, wherein the first query corresponds to the first chunk of the time window, and wherein the second query corresponds to the second chunk of the time window;
hashing the first statement associated with the first query to produce the first key and hashing the second statement associated with the second query to produce the second key;
retrieving the first portion of the data corresponding to the first chunk of the time window from cache responsive to a determination that the first key is in the cache; and
retrieving the second portion of the data corresponding to the second chunk of the time window from the cache responsive to a determination that the second key is in the cache.

4. The method of claim 2, wherein the method includes:
receiving a further API request for data from the database, wherein the further request defines a different time window associated with the data, and wherein the different time window includes the second chunk;
creating the second query and a third query based on the further request, wherein the third query corresponds to a third chunk of the different time window;
hashing the second statement associated with the second query to produce the second key and hashing a third statement associated with the third query to produce a third key;
retrieving the second portion of the data corresponding to the second chunk from cache responsive to a determination that the second key is in the cache; and
retrieving a third portion of the data corresponding to the third chunk of the different time window from the database responsive to a determination that the third key is not in the cache.

5. The method of claim 1, wherein the data is time series data.

6. The method of claim 1, wherein the method includes hashing the first statement and hashing the second statement using a SHA1 hash.

7. The method of claim 1, wherein the method includes dividing the time window into a plurality of chunks.

8. The method of claim 7, wherein the method includes determining a duration of each chunk based on a duration of the time window.

9. A non-transitory machine-readable medium having instructions stored thereon which, when executed by a processor, cause the processor to:
receive an application programming interface (API) request for data from a database, wherein the request defines a time window of the data;
create a first query and a second query based on the request, wherein the first query corresponds to a first chunk of the time window, and wherein the second query corresponds to a second chunk of the time window;
hash a first statement associated with the first query and a second statement associated with the second query;
retrieve a first portion of the data corresponding to the first chunk of the time window from cache responsive to a determination that a key corresponding to the hash of the first statement is in the cache; and
retrieve the first portion of the data corresponding to the first chunk of the time window from the database responsive to a determination that the key corresponding to the hash of the first statement is not in the cache.

10. The medium of claim 9, including instructions to:
retrieve a second portion of the data corresponding to the second chunk of the time window from cache responsive to a determination that a key corresponding to the hash of the second statement is in the cache; and
retrieve the second portion of the data corresponding to the second chunk of the time window from the database responsive to a determination that the second key is not in the cache.

11. The medium of claim 9, wherein the first chunk and the second chunk are a same duration.

12. The medium of claim 9, wherein the first chunk and the second chunk are each 10 minutes in duration.

13. The medium of claim 9, including instructions to retrieve the first portion of the data corresponding to the first chunk of the time window from the database responsive to an indication made by a user not to retrieve the first portion of the data from cache.

14. The medium of claim 9, including instructions to retrieve the first portion of the data corresponding to the first chunk of the time window from the database responsive to a determination that the first portion of the data does not exceed an age threshold.

15. The medium of claim 9, wherein the data describes a performance indicator for a cellular tower.

16. The medium of claim 9, wherein the data is sensor data.

17. A system, comprising:
a request engine configured to receive an application programming interface (API) request for data from a database, wherein the request defines a time window of the data;
a query engine configured to create a first query and a second query based on the request, wherein the first query corresponds to a first chunk of the time window, and wherein the second query corresponds to a second chunk of the time window;
a hash engine configured to hash a first statement associated with the first query and a second statement associated with the second query;
a cache engine configured to retrieve a first portion of the data corresponding to the first chunk of the time window from cache responsive to a determination that a key corresponding to the hash of the first statement is in the cache; and
a database engine configured to retrieve the first portion of the data corresponding to the first chunk of the time window from the database responsive to a determination that the key corresponding to the hash of the first statement is not in the cache.

18. The system of claim 17, wherein the first chunk and the second chunk have different durations.

19. The system of claim 17, wherein a duration of the first chunk is exceeded by a duration of the second chunk.

20. The system of claim 19, wherein the first chunk is associated with a beginning of the time window.
